(19) United States
(12) Patent Application Publication
(10) Pub. No.: US 2008/0167759 A1
(43) Pub. Date: Jul. 10, 2008

(54) DEVICE AND METHOD FOR OPERATING IN-AUTOMOBILE DEVICE THROUGH EXISTING AUTOMOBILE SECURITY SYSTEM

(76) Inventor: Pei-Cheng CHIU, Kaohsiung City (TW)

Correspondence Address: LEONG C LEI, PMB # 1008, 1867 YGNACIO VALLEY ROAD, WALNUT CREEK, CA, 94598, US

(21) Appl. No.: 11/621,567

(22) Filed: Jan. 10, 2007

(51) Int. Cl. G05D 99/00; G06F 9/44

(52) U.S. Cl. 701/2; 701/46

(57) ABSTRACT

Disclosed are a method and a device for operating an in-automobile device through an existing security system of an automobile. The device includes a controller that includes a CPU based control circuit connected to a radio frequency receiver circuit, a power supply and voltage regulation circuit, and a relay switching system. The controller is electrically connected to control circuits of in-automobile devices so that the controller can be controlled by a remote controller of the security system of the automobile to effect operation of the in-automobile device and to enhance functionality of the in-automobile devices and the security system of the automobile.

### BACKGROUND OF THE INVENTION

(a) Technical Field of the Invention

The present invention relates to a device and a method for operating in-automobile devices through a security system existing in the automobile, and in particular to a device and a method that enable operation of the in-automobile devices other than those controlled by an automobile security system by using a remote controller of the security system so as to enhance the operation of the in-automobile devices.

(b) Description of the Prior Art

Currently, most automobiles are equipped with an automobile security system 1, of which an example is illustrated in FIG. 1. The automobile security system 1 comprises a remote controller 11 and a security host device 12 arranged in an automobile. The remote controller 11 is carried by a user or driver, while the security host device 12 is electrically connected to a central door locking device 121, an ignition system 122, a fuel supply system 123, and a lighting/sound alarm system 124 of the automobile. When the driver carrying the remote controller 11 is located within an effective range of the security host device 12 and actuate the remote controller 11 to release security setting of the automobile, the central door locking device 121 is unlocked, the ignition system 122 and fuel supply system 123 enter standby condition for ignition and starting the engine. The driver may now open an automobile door and insert a car key into an ignition lock to start the engine. On the other hand, when the driver leaves the automobile and actuates the remote controller 11 to transmit a signal to secure the automobile, the security host device 12 sets the ignition system 122 and the fuel supply system 123 to shut-down condition to cut off power and fuel supply and the central door locking device 121 is commanded to lock the doors. As such, the automobile is set to a secured condition.

However, the automobile security system 1, once installed, is fixed with respect to the controllable items, including door locking/unlocking and interrupting/resuming power and fuel supply. Incorporation of additional controllable items into the original automobile security system 1 is generally not possible, unless a new and function-enhanced security system 1 substitutes the original one. However, replacing the security system cannot be done by the general consumers themselves and mechanics or skilled workers are needed. Further, newly developed, advanced devices are continuously available for automobiles that are equipped with systems and/or device that are out of date. The new devices are often additionally mounted to the automobile but cannot be integrated with the original security and operation of the automobile.

Thus, it is desired to enhance the operation and/or control of in-automobile devices and to enhance related functionality of the automobile without causing risk to safe operation of the automobile.

### SUMMARY OF THE INVENTION

The primary purpose of the present invention is to provide a method and a device for operating an in-automobile device through an existing security system of an automobile, wherein the existing security system of the automobile is preserved and a controller is additionally provided in the automobile. The controller comprises a CPU based control circuit connected to a radio frequency receiver circuit, a power supply and voltage regulation circuit, and a relay switching system, wherein the radio frequency receiver circuit receives a radio frequency transmitted from a remote controller of the security system of the automobile; the CPU based control circuit is configured to connect a variety of functions provided in the automobile and can detect setting/releasing of a secured mode of the security system of the automobile so as to integrate the device of the present invention with the existing security system of the automobile and to make the device of the present invention controllable by the remote controller of the security system of the automobile to thereby realize functionality enhancement of the devices of the automobile.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

The present invention will be apparent to those skilled in the art by reading the following description of preferred embodiments thereof, with reference to the attached drawings, wherein:

FIG. 1 is a block diagram of a conventional automobile security system;

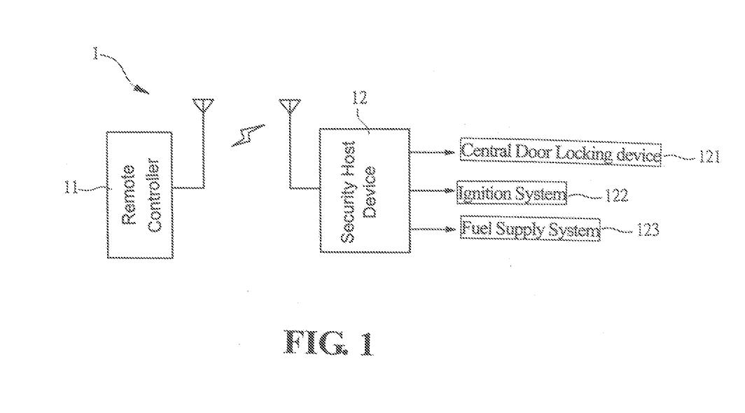

FIG. 2 is a block diagram of the present invention;

FIG. 3 is a block diagram of an application of the present invention;

FIG. 4 is a block diagram of an example of the present invention that is coupled to a power car window of an automobile; and

FIG. 5 is a block diagram of an example of the present invention that is coupled to an additionally equipped in-automobile device, which is a power-driving sun shade, of an automobile.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

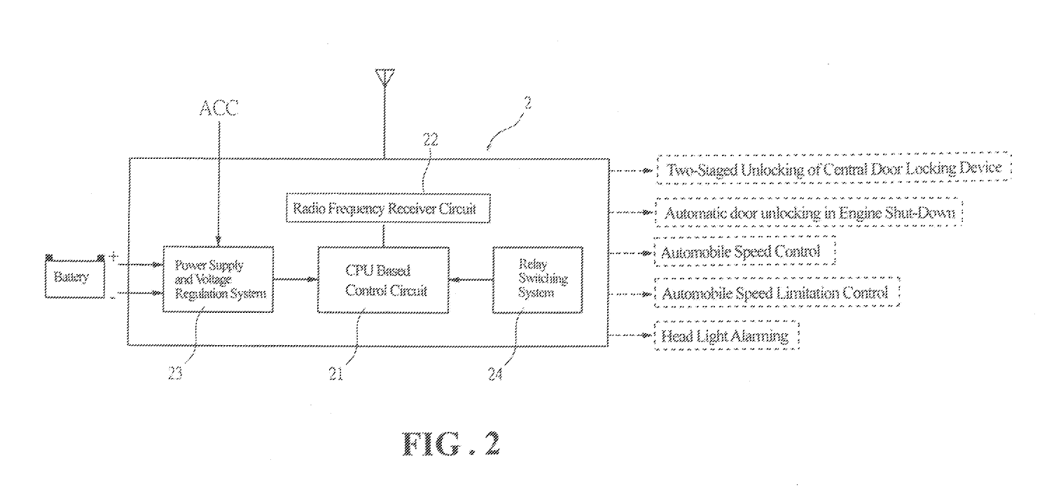

With reference to the drawings and in particular to FIG. 2, which shows a device for operating an in-automobile device though a security system that already exists in the automobile in accordance with the present invention, the device comprises a controller 2, which comprises a CPU (central processing unit) based control circuit 21 that is electrically connected to a radio frequency receiver circuit 22, a power supply and voltage regulation system 23, and a relay switching system 24.

The CPU based control circuit 21 of the controller 2 is configured to control a number of in-automobile devices and is electrically connected to the devices that are not directly controlled by a security host device 12 of the automobile security system 1. For example, the CPU based control circuit 21 of the controller 2 can be connected to an activation device of a central door locking device to operate the door central locking device to unlock in a two-staged fashion and/or to automatically unlock the automobile door when the engine of the automobile is shut down, or connected to a pulse signal generation line of a control computer of the automobile to carry out cruise speed control and speed limitation control, or connected to a head light set to issue a warning when the head light set is not turned off after the engine is shut down, or alternatively, the CPU based control circuit 21 can be connected to other devices, such as the central door locking device, an alarm, and the head light for detection the operation and/or status of these devices. The radio frequency receiver circuit 22 is configured to receive the radio frequency that is emitted by a remote controller 11 of the automobile security system 1. The power supply and voltage regulation system 23 is connected to an ACC power switch of ignition lock, which is often provided in the steering column of the automobile. The relay switching system 24 is operable based on output of power supply.

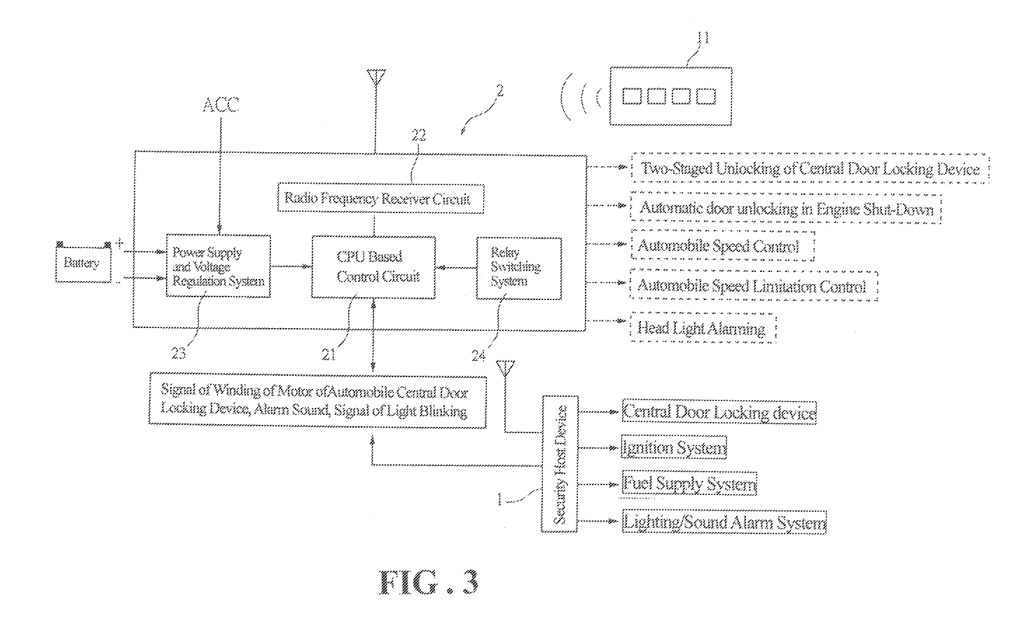

Also referring to FIG. 3, when a user operates the remote controller 11 of the automobile security system 1 to enter a secured mode, the security system 1 switches security-related or burglary-resistant facility of the automobile into the secured mode and at the same time, the radio frequency receiver circuit 22 of the controller 2 of the present invention also receives the radio frequency transmitted from the remote controller 11 and in response thereto, the CPU based control circuit 21 starts to detect if all the security-related devices are activated, such as if the central door locking device is set to a locked condition, if the light blinks, if the horn sounds, or if the alarm sounds. Upon confirming all the security-related devices are activated, the CPU based control circuit 21 activates security function thereof for automobile in a non-operation condition. On the other hand, when the remote controller 11 is operated to release the security setting of the automobile through the security system 1, the CPU based control circuit 21 detects if all the security-related devices are de-activated and if de-activation is confirmed, the CPU based control circuit 21 activates the in-automobile devices that are additionally controlled by the controller 2 of the present invention.

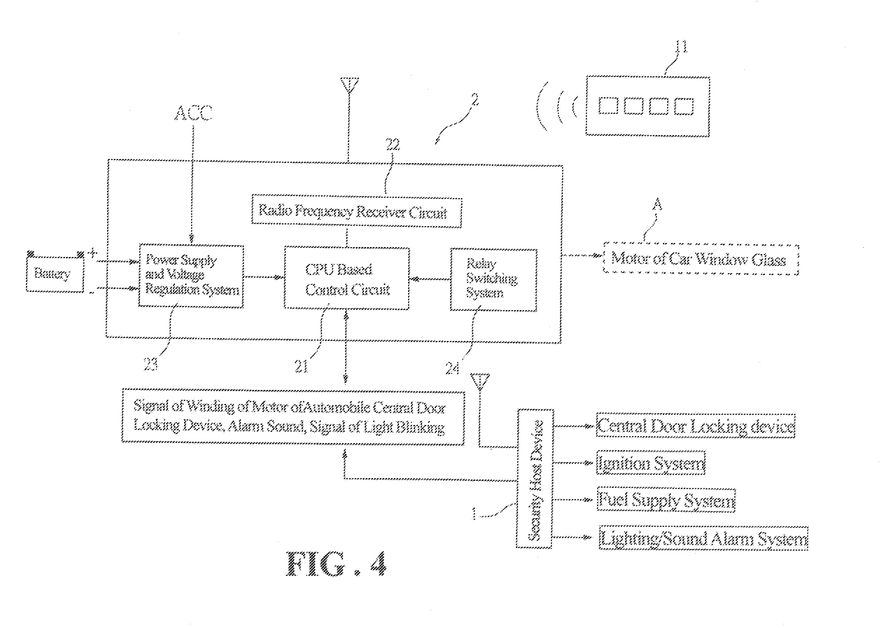

In a second embodiment of the present invention, the CPU based control circuit 21 of the controller 2 of the present invention is configured to connect and control in-automobile devices that are already provided in the automobile. In the following description, a car window is taken as an example for explanation. As shown in FIG. 4, the controller 2 is electrically connected to a driving motor A of a car window glass. As mentioned above, the CPU based control circuit 21 is electrically connected to the security host device 12 of the automobile security system 1 that is already provided in the automobile and is capable to detect the activation and/or de-activation of the security-related devices of the automobile that are controlled by the existing security system 1, such as if the central door locking device is locked or unlocked, if the light of the automobile blinks or not, if the horn of the automobile sounds or not, or if the security alarm sounds or not. The radio frequency receiver circuit 22 is configured to receive the radio frequency transmitted by the remote controller 11 of the automobile security system 1. When the driver leaves the automobile and operates the remote controller 11 of the security system 1 within an effective range in a predetermined manner, such as continuously depressing a particular pushbutton of the remote controller 11 for a preset period of time or actuating the pushbutton in a predetermined intermitting manner, to transmit a preset radio frequency signal. The radio frequency receiver circuit 22 receives the preset radio frequency signal and the CPU based control circuit 21 detects if the security-related devices of the automobile are activated to determine if the received signal is a signal intended for the subject automobile (because no matter the security-related devices are set or not, a transient current or signal can be detected when the devices are activated again). Once the CPU based control circuit 21 determines that the signal is for the automobile, the CPU based control circuit 21 issues a signal to control the window glass driving motor A to rotate forward or backward for lowering or raising the window glass. In this way, the remote controller 11 of the existing automobile security system 1 can provide a wireless control over the car window glass and the functionality of the remote controller 11 is enhanced.

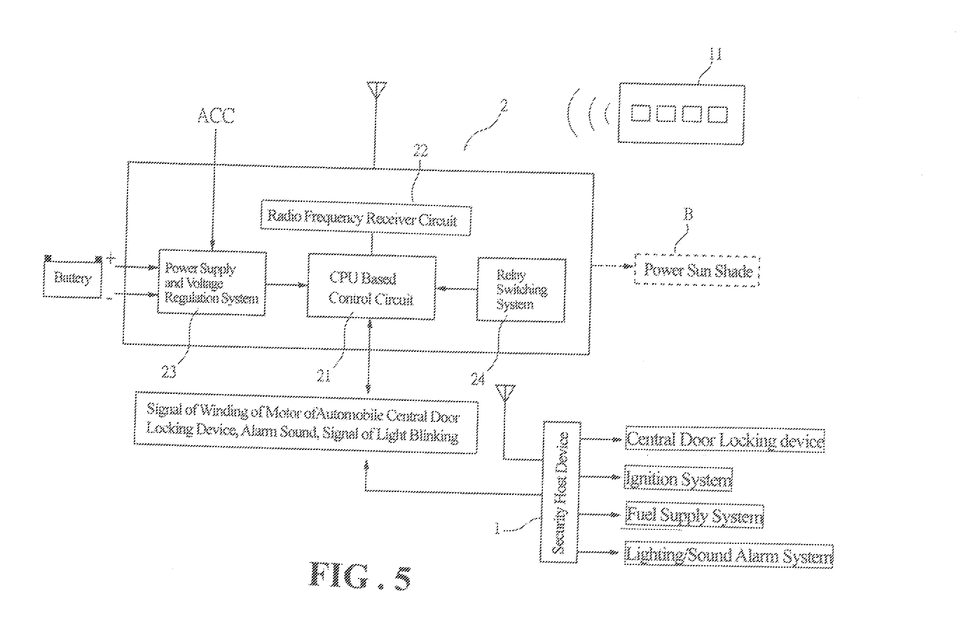

In a third embodiment, when an automobile is equipped with additional devices, the present invention can be employed to combine the additional devices with the existing security system of the automobile whereby the additional devices can be operated with the remote controller of the existing security system. In the following description, a power-driving sun shade is taken as an example for explanation, as illustrated in FIG. 5. The controller 2 of the present invention is electrically connected to the power sun shade, which is designated at B in FIG. 5, and the CPU based control circuit 21 of the controller 2 is connected to the security host device 12 of the existing security system 1 that is already present in the automobile to detect activation and/or de-activation of the security-related devices of the automobile, such as if the central door locking device is locked or unlocked, if the light of the automobile blinks or not, if the horn of the automobile sounds or not, or if the security alarm sounds or not. The radio frequency receiver circuit 22 is configured to receive the radio frequency transmitted by the remote controller 11 of the automobile security system 1. A driver, when sitting in the automobile, can control the sun shade through a switch set in the automobile. When the driver leaves or is located outside the automobile, the drive may control the sun shade through operation of the remote controller 11 of the security system 1 in a predetermined manner to transmit a preset radio frequency signal. The radio frequency receiver circuit 22 receives the preset radio frequency signal and the CPU based control circuit 21 determines if the received signal is a signal intended for the subject automobile, similar to what discussed above. Once the CPU based control circuit 21 determines that the signal is for the automobile, the CPU based control circuit 21 issues a signal to control a driving motor of the sun shade B to rotate forward or backward for lowering or raising the sun shade B. In this way, the remote controller 11 of the existing automobile security system 1 can provide a wireless control over an additionally equipped device (the power sun shade) of the automobile.

The feature of the present invention resides in that the radio frequency receiver circuit of the controller in accordance with the present invention is configured to receive radio frequency transmitted from a remote controller of the security system that already exists in the automobile so that the operation of the CPU based control circuit can be effected without replacing the existing security system. In fact, the operation is realized through the use of the remote controller of the existing security system so that no additional controller needs to be carried by a driver. The operation of the present invention is easy and, based on which the functionality of the security system and other in-automobile devices that are provided in the automobile can be enhanced.

Although the present invention has been described with reference to the preferred embodiments thereof, it is apparent to those skilled in the art that a variety of modifications and changes may be made without departing from the scope of the present invention which is intended to be defined by the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for operating an in-automobile device through an existing security system of an automobile, wherein a controller is provided and connected to the security system of the automobile, the controller being connected to the in-automobile device and being configured to detect activation/de-activation of security-related devices originally connected to and controlled by a security host device of the security system, and being further configured to receive a radio frequency transmitted from a remote controller of the security system; and the remote controller of the security system being operated in a preset manner to transmit a preset radio frequency signal, which is received by a radio frequency receiver circuit of the controller to actuate a CPU based control circuit of the controller to detect the activation/de-activation of the security-related devices that are connected to and controlled by the security host device of the security system whereby when the activation/de-activation is confirmed, the CPU based control circuit generates a signal to set and/or release the in-automobile device connected thereto.

2. A device adapted to operate an in-automobile device through an existing security system of an automobile, comprising a controller that is connected to a security host device of the security system of the automobile and controllable by a remote controller of the security system of the automobile, the controller comprising:
a CPU based control circuit, which is configured to connect the in-automobile device and to detect activation/de-activation of security-related devices originally connected to and controlled by the security host device of the security system of the automobile;
a radio frequency receiver circuit, which is configured to receive a radio frequency transmitted from the remote controller of the security system of the automobile;
a power supply and voltage regulation system, which is connected to an ignition switch of the automobile; and
a relay switching system operable based on output of power supply.
